(19) United States
(12) Patent Application Publication
(10) Pub. No.: US 2009/0016237 A1
(43) Pub. Date: Jan. 15, 2009

(54) ACCOUNTING APPARATUS AND METHOD IN PORTABLE INTERNET SYSTEM

(75) Inventor: Jun Ho Chung, Gyeonggi (KR)

Correspondence Address: BLANK ROME LLP, 600 NEW HAMPSHIRE AVENUE, N.W., WASHINGTON, DC, 20037, US

(73) Assignee: Posdata Co., Ltd.

(21) Appl. No.: 12/159,876

(22) PCT Filed: Jan. 9, 2007
(86) PCT No.: PCT/KR07/00139

§ 371 Date: Jul. 2, 2008

(30) Foreign Application Priority Data
Jan. 11, 2006 (KR) 10-2006-003066

(51) Int. Cl. H04L 12/56; G06Q 10/00; H04W 88/18

(52) U.S. Cl. 370/253; 705/30; 370/338

(57) ABSTRACT

Provided are an accounting apparatus and method in a portable Internet system. According to the apparatus and method, when an accounting report is periodically performed or service status change, such as service generation/change/deletion, is requested from a portable subscriber station (PSS), accounting information for all service flows in progress at the timing of an accounting report is transferred to an accounting server according to one accounting report period. Thus, it is possible to minimize accounting information loss, reduce a network load caused by accounting message transfer, and perform accounting transaction differentiated according to service classes. Therefore, while minimizing influence on overall portable Internet system performance, accurate accounting information for the PSS can be obtained and accounting methods can be embodied to be differentiated according to service classes. Consequently, a more consistent accounting can be achieved between a user and a service provider.

### TECHNICAL FIELD

The present invention relates to an accounting apparatus and method in a portable Internet system, and more particularly, to an accounting apparatus and method that are capable of accurately measuring and reporting the amount of data used by a portable subscriber station (PSS) while minimizing influence on the entire system's performance.

### BACKGROUND ART

The portable Internet system is an advanced Internet system within the wireless local area network (WLAN). Unlike a conventional wireless Internet system, in the portable Internet system a plurality of service connections can be established for each user, and various service classes can be supported according to the connection setups.

In a portable Internet system as described above, since accounting data need to be highly accurate. In particular, since accounting data are used as basic data for network expansion through the traffic analysis, it is very important to accurately collect them.

However, accounting data items and an accounting method conforming to the concept of the portable Internet system have not been defined so far. Accounting methods currently used in mobile communication systems are based on a single service provision method as illustrated in FIG. 1, which will be described in detail below.

FIG. 1 illustrates a conventional accounting method, showing a process in which accounting messages are transferred to an accounting server when service generation/deletion are requested from a PSS.

In FIG. 1, “DSA #” denotes a service generation event, “DSD #” denotes a service deletion event, “Start SF#” denotes the start of accounting for the corresponding service flow, “Interim SF#” denotes accounting information for the corresponding service flow at the time for an interim accounting report, and “Stop SF#” denotes the stop of accounting for the corresponding service flow.

For convenience, it is assumed that a radio access station (RAS) periodically generates and transfers an accounting message to an accounting server according to an accounting report period.

First, when a first service is requested from the PSS (DSA 1), the RAS generates an accounting report timer for the first service, thereby starting accounting (Start SF1). The RAS periodically includes accounting information for a first service flow in an accounting message and transfers it to the accounting server according to an accounting report period (Interim SF1).

Subsequently, when deletion of the first service is requested from the PSS (DSD 1), the RAS deletes the accounting report timer for the first service and simultaneously stops accounting for the first service (Stop SF1). In addition, the RAS inserts accounting information for data packets hitherto provided into an accounting message and transfers it to the accounting server.

Subsequently, when a second service is requested from the PSS (DSA 2), the RAS generates an accounting report timer for the second service to start accounting (Start SF2). The RAS inserts accounting information for a second service flow into an accounting message and transfers it to the accounting server according to an accounting report period (Interim SF2).

Subsequently, when deletion of the second service is requested from the PSS (DSD 2), the RAS deletes the accounting report timer for the second service and simultaneously stops accounting for the second service (Stop SF2). In addition, the RAS inserts accounting information for data packets hitherto provided into an accounting message and transfers it to the accounting server.

As described above, the conventional accounting method assumes that one service is activated at a specific time and transfers accounting information according to the service. Thus, it is difficult to apply the conventional accounting method to a portable Internet system in which a PSS can simultaneously request several services.

In addition, when an accounting message carrying accounting information for an overall service is lost, the conventional accounting method performs accounting transactions using accounting information carried in the final transfer accounting message in order to minimize accounting information loss caused by the message loss. Therefore, there is a difference between the amount of data packets that are actually provided and the amount of data packets that are billed, and hence the difference is imbalanced for a network operator.

In order to prevent such accounting information loss and to obtain relatively accurate accounting information, a method which has a short accounting report period is suggested. However, data packets to be transmitted and received for counting and accounting report increase, so a network overload may generate.

As described above, the portable Internet system must have an accounting function that accurately measures and reports a subscriber's usage while minimizing traffic in an entire network. However, since there is a trade-off between the amount of traffic and the accuracy of accounting in a system, it is undesirable to apply the current accounting method in mobile communication systems to a portable Internet system without modifications. Thus, an accounting policy appropriate for the portable Internet system is required.

In addition, since one PSS can request several services in a portable Internet system, there is a demand for a process that is capable of managing accounting information of each service flow separately.

In other words, the conventional accounting method performs accounting transactions using only the amount of data packets and the service duration used by a PSS. In a portable Internet system, however, since various services can be provided to each PSS, a function for separately transferring or collecting accounting data of each service class is required.

Henceforth, in a portable Internet system, there is a demand for an accounting method which can minimize accounting information loss, reduce a network load caused by accounting message transfer, and perform accounting transaction appropriate to the characteristics of the various services provided to a PSS.

### DISCLOSURE OF INVENTION

### Technical Problem

The present invention is directed to an accounting apparatus and method in a portable Internet system providing at least one simultaneous service, which perform accounting report for all service flows in progress at the timing of an accounting report according to one accounting report period, thereby reducing a network load caused by accounting message transfer, and accurately measuring and reporting the amount of data used by a portable subscriber station (PSS).

The present invention is also directed to an accounting apparatus and method in a portable Internet system capable of providing each user with several services, which record and manage accounting information for each service flow session by session, thereby performing accounting transactions differentiated according to service classes.

### Technical Solution

One aspect of the present invention provides an accounting apparatus in a portable Internet system capable of providing a PSS with at least one service during a pre-determined time, the apparatus comprising: an accounting report timer for generating a timing signal according to an accounting report period in response to a service request from the PSS; an accounting processing unit for providing accounting information for at least one service flow in progress to an accounting server in response to the timing signal of the accounting report timer; and a memory unit for storing an accounting table in which the accounting information is recorded according to at least one service flow provided to the PSS.

Another aspect of the present invention provides an accounting apparatus in a portable Internet system capable of providing at least one service to a PSS during a predetermined time, the apparatus comprising: an accounting report timer for generating a timing signal according to an accounting report period in response to a request for a first service from the PSS; and an accounting processing unit for periodically providing accounting information for the first service to an accounting server in response to the timing signal, and when a second service is requested from the PSS during provision of the first service, providing accounting information for the second service as well as the accounting information for the first service to the accounting server in response to the timing signal.

Still another aspect of the present invention provides an accounting method in a portable Internet system providing an accounting server with accounting information for at least one service provided to a PSS, the method comprising the steps of: (a) when at least one service is requested from the PSS, determining whether an accounting report timing signal exists or not; (b) when a new accounting report timing signal is needed, generating an accounting report timer for the service and setting an accounting report timing signal of the generated accounting report timer as a reference accounting report timing signal; and (c) providing accounting information for at least one service flow in progress to the accounting server in response to the timing signal of the accounting report timer.

Yet another aspect of the present invention provides an accounting method in a portable Internet system providing an accounting server with accounting information for at least one service provided to a PSS, the method comprising the steps of: (a) when a first service is requested from the PSS, periodically generating an accounting report timing signal and providing accounting information for the first service to the accounting server; (b) when a second service is requested from the PSS between a first timing signal and a second timing signal among the accounting report timing signals, providing accounting information for the first and second services to the accounting server upon generation of the second timing signal; and (c) providing the accounting information for the first and second services to the accounting server according to the period of the accounting report timing signals.

### ADVANTAGEOUS EFFECTS

As described above, according to the accounting method of the present invention, accounting information for service flows in progress is transferred to an accounting server at a time according to one accounting report period. Thus, it is possible to collectively perform accounting transaction for all service flows by transferring a less amount of accounting information.

Meanwhile, the above-described exemplary embodiments of the present invention can be embodied as computer programs stored on computer readable media and capable of being executed by a computer.

As described above, according to the present invention, accounting information for service flows in progress is transferred to an accounting server at a time according to one accounting report period. Thus, in comparison with a conventional accounting method, it is possible to reduce a network load caused by accounting message transfer and minimize accounting information loss. Consequently, accurate accounting information for a PSS can be obtained.

In addition, according to the present invention, accounting information for all service flows activated for a PSS is transferred at a time to an accounting server. Thus, an accounting information processing procedure is simplified, and accounting transaction can be performed more promptly and easily.

In addition, in comparison with a conventional accounting method by which information services having different characteristics such as a telephone service, a data service, a video application service, etc. all are considered as one service class, accounting methods differentiated according to service classes can be embodied according to the present invention. Thus, in a portable Internet system capable of providing several services to each user, more reasonable accounting can be made between users and a service provider, and the service provider can expect efficient network operation and benefit.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 illustrates a conventional accounting method;

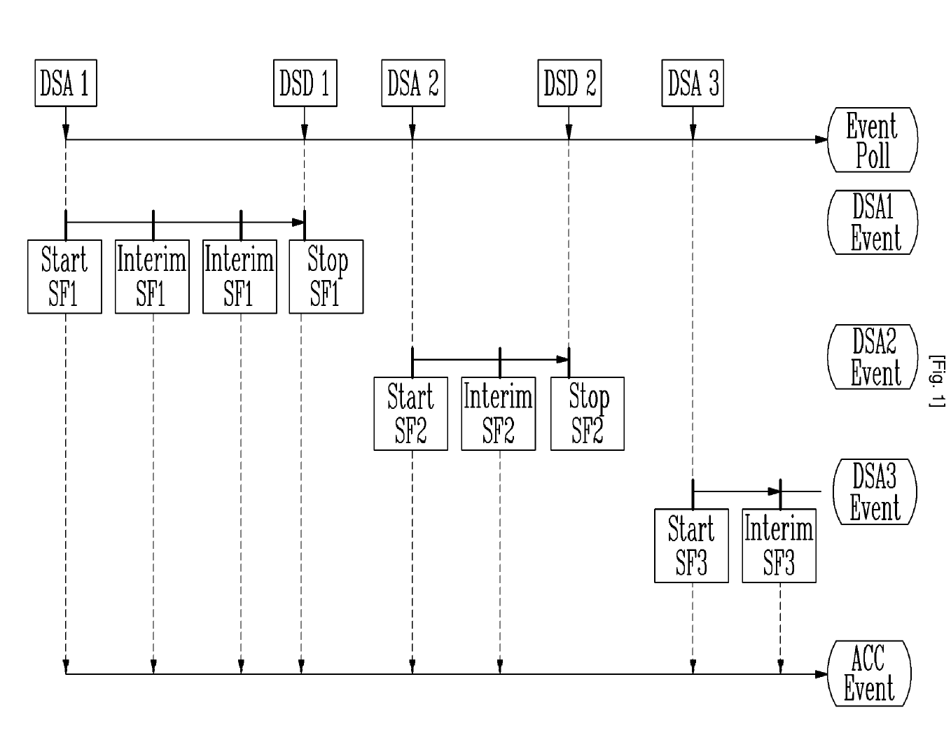

FIG. 2 schematically illustrates a configuration of a portable Internet system employing the present invention;

FIG. 3 illustrates a process in which accounting messages are transferred to an accounting server in a portable Internet system employing a conventional accounting method;

FIG. 4 is a block diagram of an accounting apparatus in a portable Internet system according to an exemplary embodiment of the present invention;

FIG. 5 illustrates operation of the accounting apparatus according to an exemplary embodiment of the present invention; and

FIG. 6 is a flowchart showing an accounting method in a portable Internet system according to an exemplary embodiment of the present invention.

### MODE FOR THE INVENTION

Hereinafter, exemplary embodiments of the present invention will be described in detail. However, the present invention is not limited to the embodiments disclosed below, but can be implemented in various forms. Therefore, the following embodiments are described in order for this disclosure to be complete and enabling to those of ordinary skill in the art.

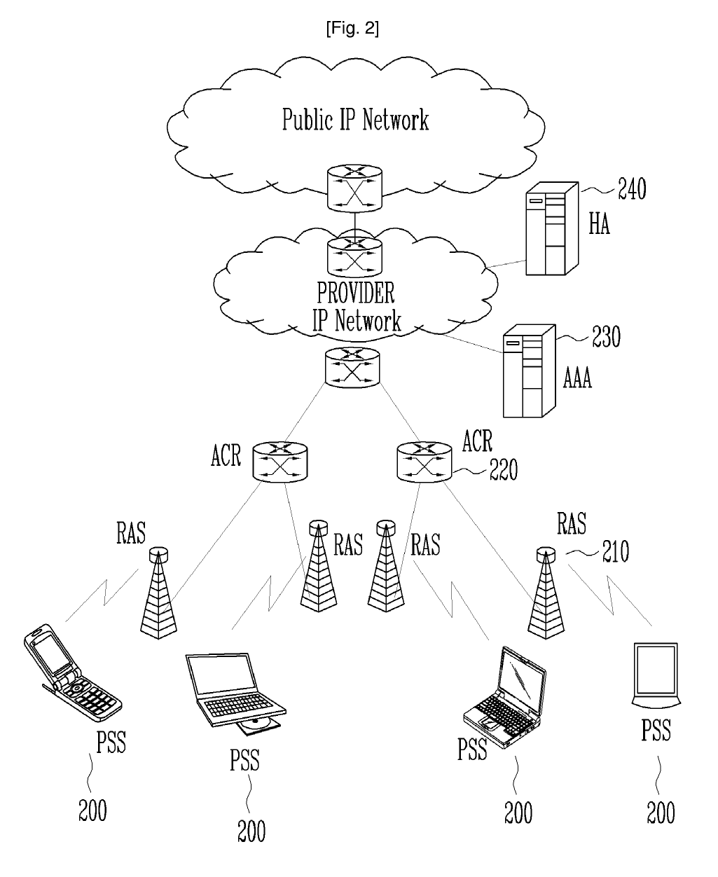

FIG. 2 schematically illustrates a configuration of a portable Internet system employing the present invention.

As illustrated in FIG. 2, the portable Internet system includes portable subscriber stations (PSSs) 200, radio access stations (RASs) 210, access control routers (ACRs) 220, an authentication, authorization and accounting (AAA) server 230, and a home agent (HA) 240. The RASs 210 perform all control functions associated with connection and servicing of the PSSs 200, and the ACRs 220 control the RASs 210. The AAA server 230 is connected to an Internet protocol (IP) network and performs authentication, authorization and accounting functions for the PSSs 200, and the HA 240 supports IP mobility through the IP network. Functions of the PSSs 200, the RASs 210, and the ACRs 220 are described below in brief.

The PSSs 200 perform portable Internet wireless connection, IP-based service connection, IP mobility, terminal/user authentication and security, multicast service reception, and interoperation with another network.

The RASs 210 have the functions of portable Internet wireless connection, wireless resource management and control, mobility (hand-off) support, authentication and security, quality of service (QoS) provision, downlink multicast, accounting, and statistical information generation and notification.

The ACRs 220 have the functions of IP routing and mobility management, authentication and security, QoS provision, IP multicast, accounting service, mobility control between RASs of each ACR, and resource management and control.

The PSSs 200 and the RASs 210 communicate using an Orthogonal Frequency Division Multiple Access (OFDMA) method, which is described below in brief.

The OFDMA method is a multiplexing method combining a frequency division method (FDM), which uses sub carriers of a plurality of orthogonal frequencies as a plurality of sub channels, with a time division method (TDM). Since the OFDMA method is essentially strong at fading generated in a multi-path and has a high data transfer rate, it is possible to obtain optimum transfer efficiency for high-speed data transfer. Thus, using the OFDMA method, portable Internet systems can provide mobility of PSSs.

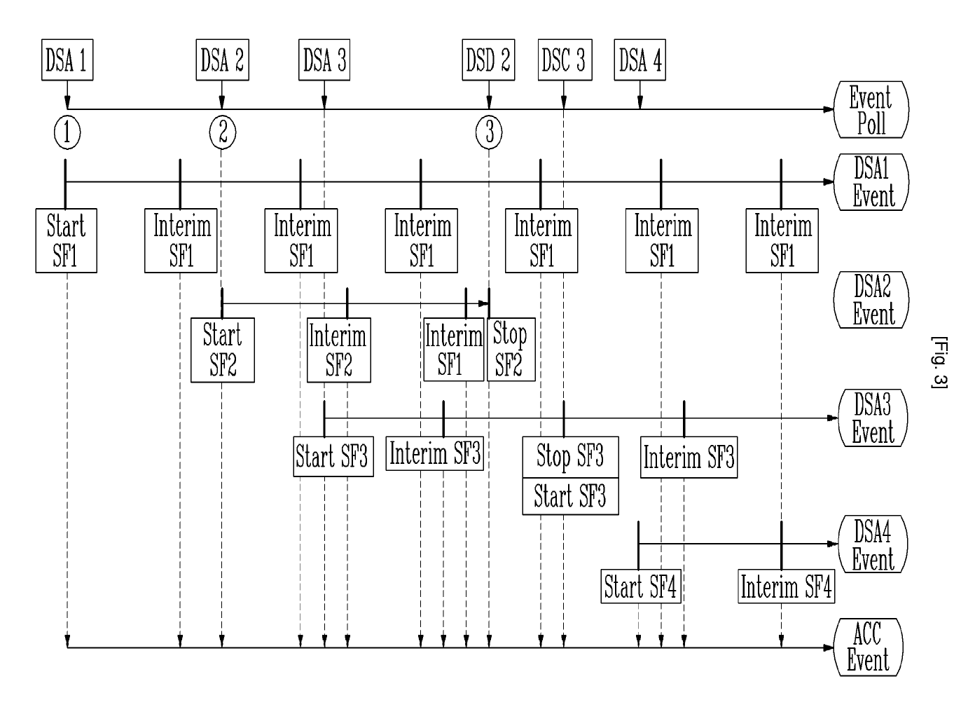

Meanwhile, accounting data items and an accounting method have not been defined so far according to the concept of the portable Internet system constituted as shown in FIG. 2. When an accounting method currently used in mobile communication systems is applied without modification to the portable Internet system, the traffic of accounting messages increases as shown in FIG. 3, making it inefficient.

FIG. 3 illustrates a process in which accounting messages are transferred to an accounting server in a portable Internet system employing a conventional accounting method.

In FIG. 3, “DSA #” denotes a service generation event, “DSC #” denotes a service change event, “DSD #” denotes a service deletion event, “Start SF#” denotes the start of accounting for the corresponding service flow, “Interim SF#” denotes accounting information for a service flow at a time for an interim accounting report, and “Stop SF#” denotes the end of accounting for the corresponding service flow.

For convenience, it is assumed that a RAS periodically generates and transfers an accounting message to an accounting server according to an accounting report period.

First, when a first service is requested from a PSS (DSA 1), the RAS generates an accounting report timer for the first service, thereby starting accounting (Start SF1). The RAS periodically inserts accounting information for a first service flow into an accounting message and transfers it to the accounting server according to an accounting report period (Interim SF1).

Subsequently, when second and third services are requested from the PSS (DSA 2 and DSA 3), the RAS generates accounting report timers for the second and third services to start accounting, respectively (Start SF2 and Start SF3). The RAS periodically inserts accounting information for the corresponding services into accounting messages and transfers them to the accounting server according to accounting report periods (Interim SF2 and Interim SF3) of the accounting report timer, respectively.

Meanwhile, when deletion of the second service is requested from the PSS (DSD 2), the RAS deletes the accounting report timer for the second service and simultaneously stops accounting for the second service (Stop SF2). In addition, the RAS inserts accounting information for data packets hitherto provided into an accounting message and transfers it to the accounting server.

Subsequently, the RAS transfers accounting information for the currently remaining first and third services to the accounting server according to the corresponding accounting report periods until the services are terminated, respectively.

In addition, when change of the third service is requested from the PSS (DSC 3), the RAS stops accounting for the third service (Stop SF3) and starts accounting for a new third service (Start SF3).

However, when accounting information for each service is separately transferred to the accounting server according to an accounting report period of the service upon generation of a service generation/change/deletion event as described above, data packets transmitted and received for accounting increase. Consequently, traffic is concentrated in the accounting server.

In order to solve the problem, the accounting apparatus according to the present invention transfers accounting information for all service flows in progress at the timing of an accounting report to an accounting server according to one accounting report period as described below. Thus, the accounting apparatus can minimize accounting information loss and reduce a network load caused by accounting message transfer. The accounting apparatus according to an exemplary embodiment of the present invention will be described in further detail below.

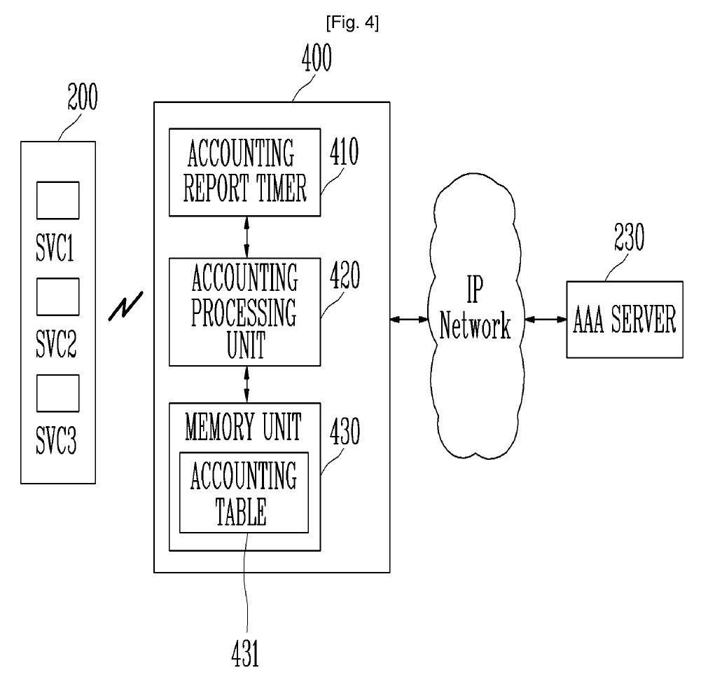

FIG. 4 is a block diagram of an accounting apparatus in a portable Internet system according to an exemplary embodiment of the present invention.

As illustrated in FIG. 4, an accounting apparatus 400 according to an exemplary embodiment of the present invention includes an accounting report timer 410, an accounting processing unit 420 and a memory unit 430. The accounting report timer 410 generates a timing signal according to an accounting report period in response to a service request from a PSS 200. The accounting processing unit 420 collects accounting information for each service flow and transfers all accounting information at a time in response to the timing signal from the accounting report timer 410. The memory unit 430 includes an accounting table 431 in which accounting information is recorded according to services.

In FIG. 4, the accounting apparatus 400 may be implemented in the RAS 210 or the ACR 220 illustrated in FIG. 2 and conforming to the Institute of Electrical and Electronics Engineers (IEEE) 802.16 standard. In this exemplary embodiment, it is assumed for convenience that the accounting apparatus 400 is implemented in the RAS 210.

When various kinds of services SVC1, SVC2 and SVC3 are requested from the PSS 200, the accounting processing unit 420 generates sessions for each service, collects accounting information of each session, and records the collected accounting information in the accounting table 431. In addition, in response to the timing signal of the accounting report timer 410, i.e., according to an accounting report period, the accounting processing unit 420 transfers accounting information for at least one service in progress at the timing of an accounting report to the AAA server 230 with reference to the accounting table 431.

The timing signal is periodically generated according to the accounting report period of the accounting report timer 410. In this exemplary embodiment, first to N-th timing signals are accounting report timing signals generated in sequence at pre-determined time periods according to the accounting report period and can be regarded to be the same as accounting report timing signals.

The accounting table 431 is constituted according to each session so as to perform accounting transaction differentiated according to service classes. Preferably, the accounting table 431 includes information on session identifications (IDs), an IP address of a PSS, an accounting type, an amount of transmitted and received packets and a number of octets of the packets, accounting start/stop times, whether or not a timing signal is generated by an accounting report timer, an accounting report period, and so on.

In other words, the accounting apparatus 400 according to the present invention transfers accounting information for all services in progress at the timing of an accounting report to the AAA server 230 according to one accounting report period. Thus, a network load for collecting accounting information is reduced, and accounting transaction is performed more promptly and easily. In addition, the accounting apparatus 400 performs accounting transaction differentiated according to service classes, thereby enabling more reasonable accounting in a portable Internet system that is capable of providing various services to each user.

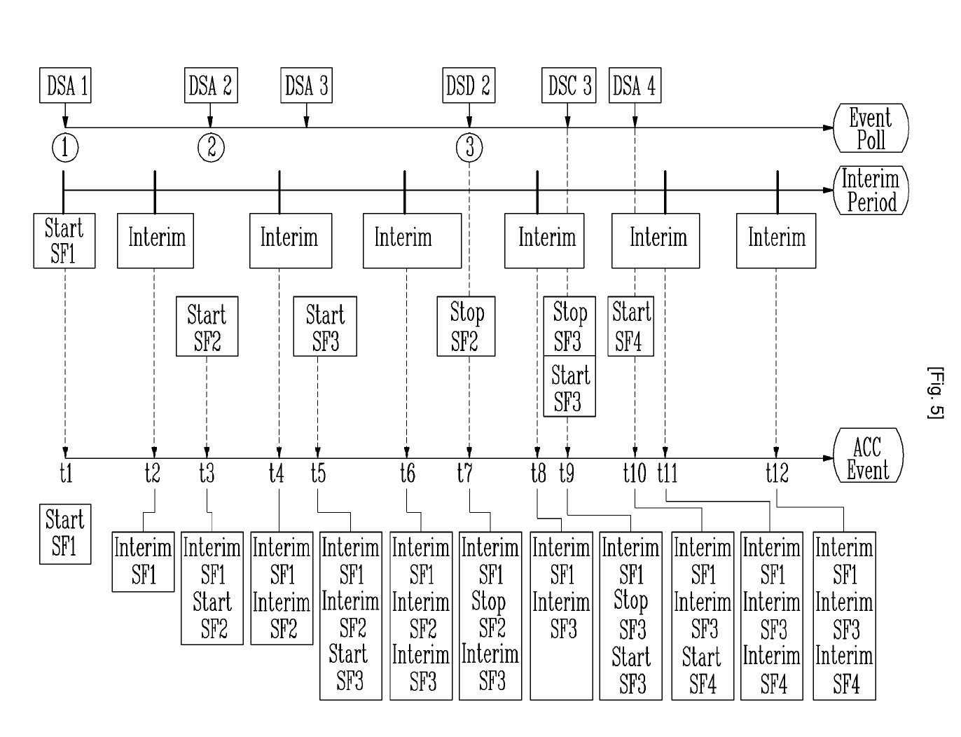

Operation of the accounting apparatus 400 will be described in further detail below with reference to FIG. 5.

FIG. 5 illustrates operation of the accounting apparatus according to an exemplary embodiment of the present invention.

In FIG. 5, “DSA #” denotes a service generation event, “DSC #” denotes a service change event, “DSD #” denotes a service deletion event, “Start SF#” denotes the start of accounting for the corresponding service flow, “Interim SF#” denotes accounting information for the corresponding service flow, and “Stop SF#” denotes the stop of accounting for the corresponding service flow.

First, when a first service flow is generated at time t1 (DSA 1), the accounting processing unit 420 generates the accounting report timer 410 for the first service flow. Simultaneously, the accounting processing unit 420 inserts accounting start information (Start SF1) of the first service flow into an accounting message and transfers it to the AAA server 230.

More specifically, when a new service is requested from the PSS 200, the accounting processing unit 420 determines whether a previously generated accounting report timing signal exists or not based on the accounting table 431 of the memory unit 430. When a new accounting report timing signal is needed, the accounting processing unit 420 generates the accounting report timer 410 for the corresponding service flow.

Here, the accounting report timer 410 generates a timing signal for accounting report at its accounting report periods, and the timing signal generated by the accounting report timer 410 is set as a reference accounting report timing signal.

More specifically, the accounting processing unit 420 renders the accounting report timer 410 to generate an accounting report timing signal for a service that is requested from the PSS 200 for the first time, and sets the timing signal of the accounting report timer 410 as a reference accounting report timing signal. When another service is requested from the PSS 200 thereafter, the accounting processing unit 420 recognizes the previously generated accounting report timing signal as the reference timing signal and does not generate an additional accounting report timing signal for the latter service.

The reference accounting report timing signal is set as described above in order to transfer accounting information for all service flows in progress to the AAA server 230 at the timing of the reference timing signal, as described below.

Subsequently, when the accounting report timer 410 informs the accounting processing unit 420 that it is a time for an interim accounting report at time t2, that is, a first timing signal is generated from the accounting report timer 410, the accounting processing unit 420 includes accounting information (Interim SF1) for the first service in progress at the timing in an accounting message and transfers it to the AAA server 230.

Here, the accounting information may correspond to a charge for one accounting report period or a total charge accumulated until the timing. Preferably, the accounting information includes information on an amount of transmitted and received packets for the corresponding service in the IP layer and a number of octets of the packets.

Subsequently, when a second service flow is generated at time t3 (DSA 2), the accounting processing unit 420 inserts accounting start information (Start SF2) of the second service flow and accounting information (Interim SF1) for the first service flow in progress at the timing into an accounting message and transfers it to the AAA server 230.

Subsequently, when the accounting report timer 410 informs to the accounting processing unit 420 again that it is a time for an interim accounting report at time t4, that is, a second timing signal is generated from the accounting report timer 410, the accounting processing unit 420 inserts accounting information (Interim SF1 and Interim SF2) for the first and second service flows in progress at the timing into an accounting message and transfers it to the AAA server 230.

Subsequently, when a third service flow is generated at time t5 (DSA 3), the accounting processing unit 420 inserts accounting start information (Start SF3) of the third service flow as well as accounting information (Interim SF1 and Interim SF2) for the first and second service flows in progress at the timing into an accounting message and transfers it to the AAA server 230.

Subsequently, when the accounting report timer 410 informs to the accounting processing unit 420 again that it is a time for an interim accounting report at time t6, that is, a third timing signal is generated from the accounting report timer 410, the accounting processing unit 420 inserts accounting information (Interim SF1, Interim SF2 and Interim SF3) for the first, second and third service flows in progress at the timing into an accounting message and transfers it to the AAA server 230.

Meanwhile, when the second service flow is deleted at time t7 (DSD 2), the accounting processing unit 420 inserts accounting stop information (Stop SF2) for the second service flow and accounting information (Interim SF1 and Interim SF3) for the first and third service flows in progress at the timing into an accounting message and transfers it to the AAA server 230.

Subsequently, when the accounting report timer 410 informs to the accounting processing unit 420 again that it is a time for an interim accounting report at time t8, that is, a fourth timing signal is generated from the accounting report timer 410, the accounting processing unit 420 inserts accounting information (Interim SF1 and Interim SF3) for the first and third service flows in progress at the timing into an accounting message and transfers it to the AAA server 230.

Subsequently, when a third service flow is changed at time t9 (DSC 3), the accounting processing unit 420 inserts accounting stop information (Stop SF3) for the third service flow, accounting start information (Start SF3) for a new third service flow, and accounting information (Interim SF1) for the first service flow in progress at the timing into an accounting message and transfers it to the AAA server 230.

Subsequently, when a fourth service flow is generated at time t10 (DSA 4), the accounting processing unit 420 inserts accounting start information (Start SF4) of the fourth service flow as well as accounting information (Interim SF1 and Interim SF3) for the first and third service flows in progress at the timing into an accounting message and transfers it to the AAA server 230.

Subsequently, when the accounting report timer 410 informs to the accounting processing unit 420 again that it is a time for an interim accounting report at time t11, that is, a fifth timing signal is generated from the accounting report timer 410, the accounting processing unit 420 inserts accounting information (Interim SF1, Interim SF3 and Interim SF4) for the first, third and fourth service flows in progress at the timing into an accounting message and transfers it to the AAA server 230.

Meanwhile, the accounting processing unit 420 renders the accounting report timer 410 to continuously generate the timing signal until all the services for the PSS 200 are terminated, that is, until termination of a service provided to the last is requested from the PSS 200. Therefore, although the first service is terminated, accounting information for other services in progress is continuously transferred to the accounting server 230 in response to the timing signal of the accounting report timer 410.

In addition, when termination of the service provided to the last among the provided services is requested, the accounting processing unit 420 stops the accounting report timer 410 from generating the timing signal, thereby halting accounting report.

As described above, when accounting report is periodically performed or a service status is changed, the accounting apparatus 400 of the present invention inserts accounting information for all service flows in progress at the timing into an accounting message and transfers it to the AAA server 230 according to one accounting report period. Therefore, it is possible to minimize accounting information loss and reduce a network load caused by accounting message transfer.

In this embodiment, it is described for convenience that the accounting report timer 410 is generated according to the first service requested from the PSS 200 for the first time and the timing signal of the accounting report timer 410 is set as the reference accounting report timing signal. However, it is also possible to set the reference accounting report timing signal according to the accounting report timer of another service, and the method of setting an accounting report timer can be changed according to a network administrator's accounting policy.

An accounting method in a portable Internet system will be described below in detail with reference to the appended drawings.

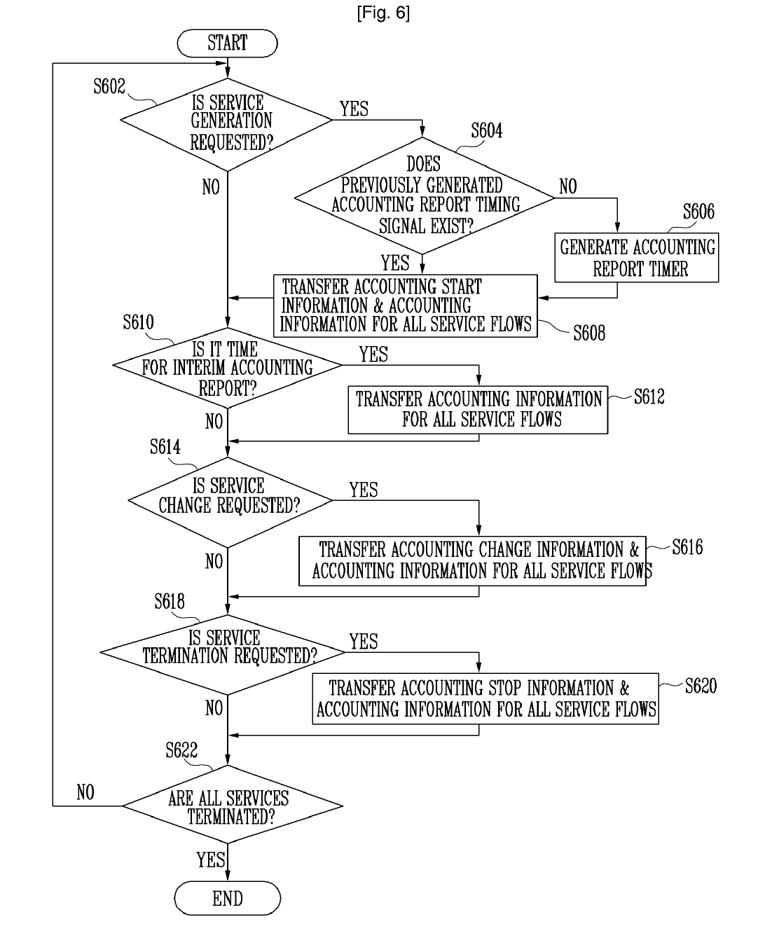

FIG. 6 is a flowchart showing an accounting method in a portable Internet system according to an exemplary embodiment of the present invention.

First, when service generation is requested from a PSS 200 in step 602, an accounting processing unit 420 determines with reference to an accounting table 431 stored in a memory unit 430 whether a previously generated accounting report timing signal exists or not in step 604. When a new accounting report timing signal is needed, the accounting processing unit 420 generates an accounting report timer 410 for the corresponding service flow in step 606.

Here, the accounting report timer 410 generates a timing signal for accounting report according to the accounting report period thereof, and the timing signal generated by the accounting report timer 410 is set as a reference accounting report timing signal.

The reference accounting report timing signal is set as described above in order to transfer accounting information for all service flows in progress at the timing to an AAA server 230 according to the reference timing signal as described below.

More specifically, the accounting processing unit 420 renders the accounting report timer 410 to generate the timing signal for the service requested from the PSS 200 for the first time and set the accounting report timing signal as the reference accounting report timing signal. When another service is requested from the PSS 200 thereafter, the accounting processing unit 420 recognizes the previously generated accounting report timing signal as the reference accounting report timing signal and does not generate an additional accounting report timing signal for subsequent services.

Here, the PSS 200 may request various kinds of services according to its characteristics. Therefore, in order to perform accounting transaction differentiated according to service classes, the accounting processing unit 420 generates sessions for the each service, collects accounting information of each session, records the collected accounting information in the accounting table 431, and then inserts the accounting information recorded in the accounting table 431 into an accounting message and transfers it to the AAA server 230 in response to the timing signal of the accounting report timer 410.

The accounting table 431 is constituted according to each session and may include information on session IDs, an IP address of a PSS, an accounting type, an amount of transmitted and received packets and a number of octets of the packets, accounting start/stop times, whether or not a timing signal is generated by the accounting report timer, an accounting report period, and so on.

Subsequently, the accounting processing unit 420 inserts accounting start information for the newly generated service flow and accounting information for all service flows in progress at the timing into an accounting message and transfers it to the AAA server 230 in step 608.

When the accounting report timer 410 informs the accounting processing unit 420 that it is a time for an interim accounting report in step 610, the accounting processing unit 420 inserts accounting information for all service flows in progress at the timing into an accounting message and transfers it to the AAA server 230 in step 612.

Here, the accounting information may correspond to a charge for one accounting report period or a total charge accumulated until the timing, and preferably includes information on an amount of transmitted and received packets for the corresponding service in the IP layer and a number of octets of the packets.

Subsequently, when service change is requested from the PSS 200 in step 614, the accounting processing unit 420 inserts accounting change information and accounting information for all service flows in progress at the timing into an accounting message and transfers it to the AAA server 230 in step 616.

Subsequently, when service termination is requested from the PSS 200 in step 618, the accounting processing unit 420 inserts accounting stop information and accounting information for all service flows in progress at the timing into an accounting message and transfers it to the AAA server 230 in step 620.

Above-described accounting message transfer continues until all services provided to the PSS 200 are terminated in step 622. To this end, the accounting processing unit 420 renders the accounting report timer 410 to keep generating the timing signal until termination of a service provided to the PSS 200 to the last is requested. Therefore, although a first service is terminated, accounting information for other services in progress is continuously transferred to the accounting server 230 in response to the timing signal of the accounting report timer 410.

Meanwhile, when termination of the service provided to the last is requested, the accounting processing unit 420 stops the accounting report timer 410 from generating the timing signal, thereby halting accounting report.

While the invention has been shown and described with reference to certain exemplary embodiments thereof, it will be understood by those skilled in the art that various changes in form and details may be made therein without departing from the spirit and scope of the invention as defined by the appended claims.

1. An accounting apparatus in a portable Internet system capable of providing a portable subscriber station (PSS) with at least one service, the accounting apparatus comprising:
an accounting report timer for generating a timing signal according to an accounting report period in response to a service request from the PSS;
an accounting processing unit for providing accounting information for at least one service flow in progress to an accounting server in response to the timing signal of the accounting report timer; and
a memory unit for storing an accounting table in which the accounting information is recorded according to at least one service flow provided to the PSS.

2. The accounting apparatus of claim 1, wherein the accounting table is configured according to each service session and includes at least one of information on session identifications (IDs), an Internet protocol (IP) address of the PSS, an accounting type, the amount of transmitted and received packets, the number of octets of the packets, accounting start/stop times, whether or not the accounting report timer generates the timing signal, and the accounting report period.

3. The accounting apparatus of claim 1, wherein the accounting processing unit determines whether an accounting report timing signal exists or not when a service is requested from the PSS, and when a new timing signal is needed, generates an accounting report timer for the service, and sets an accounting report timing signal of the generated accounting report timer as a reference accounting report timing signal.

4. The accounting apparatus of claim 1, wherein the accounting processing unit generates sessions for each service flow for at least one service requested from the PSS, collects accounting information of each session, and records the collected accounting information in the accounting table.

5. The accounting apparatus of claim 1, wherein when at least one of service generation, service change and service deletion is requested from the PSS, the accounting processing unit provides the accounting server with at least one of accounting start, change and stop information corresponding to the request.

6. The accounting apparatus of claim 1, wherein when at least one of service generation, service change and service deletion is requested from the PSS, the accounting processing unit provides the accounting server with the accounting information for at least one service flow in progress at the timing of the request.

7. The accounting apparatus of claim 1, wherein the accounting apparatus is implemented in a radio access station (RAS) or access control router (ACR) conforming to Institute of Electrical and Electronics Engineers (IEEE) 802.16 standard.

8. An accounting apparatus in a portable Internet system capable of providing a PSS with at least one service, the accounting apparatus comprising:
an accounting report timer for generating a timing signal according to an accounting report period in response to a request for a first service from the PSS; and
an accounting processing unit for periodically providing accounting information for the first service to an accounting server in response to the timing signal, and when a second service is requested from the PSS during provision of the first service, providing accounting information for the second service as well as the accounting information for the first service to the accounting server in response to the timing signal.

9. The accounting apparatus of claim 8, wherein when the second service is requested from the PSS, the accounting processing unit provides the accounting server with start information of the second service and accounting information for the first service.

10. The accounting apparatus of claim 8, wherein when termination of at least one of the first and second services is requested from the PSS, the accounting processing unit provides the accounting server with stop information of a service corresponding to the termination request and accounting information for a service in progress.

11. The accounting apparatus of claim 8, wherein when a third service is requested from the PSS during provision of the first and second services, the accounting processing unit provides the accounting server with accounting information for the third service as well as the accounting information for the first and second services in response to the timing signal.

12. The accounting apparatus of claim 11, wherein when the third service is requested from the PSS, the accounting processing unit provides the accounting server with start information of the third service and the accounting information for the first and second services.

13. The accounting apparatus of claim 11, wherein when termination of at least one of the first to third services is requested, the accounting processing unit provides the accounting server with stop information of a service corresponding to the termination request and accounting information for a service in progress.

14. The accounting apparatus of claim 8, wherein when the first service is terminated, the accounting processing unit provides the accounting information for the second service to the accounting server in response to the timing signal.

15. The accounting apparatus of claim 8, wherein the accounting report timer stops generating the timing signal when termination of a service provided to the PSS to the last is requested.

16. The accounting apparatus of claim 8, wherein when at least one service is requested from the PSS, the accounting processing unit determines whether a previously generated timing signal exists or not, and when a new timing signal is needed, generates an accounting report timer for a corresponding service flow and sets an accounting report timing signal of the generated accounting report timer as a reference accounting report timing signal.

17. The accounting apparatus of claim 8, further comprising: a memory unit for storing an accounting table in which the accounting information is recorded according to each service flow.

18. The accounting apparatus of claim 8, wherein the accounting apparatus is implemented in a RAS or ACR conforming to the IEEE 802.16 standard.

19. An accounting method in a portable Internet system providing an accounting server with accounting information for at least one service provided to a PSS, the method comprising the steps of:
(a) when at least one service is requested from the PSS, determining whether an accounting report timing signal exists or not;
(b) when a new accounting report timing signal is needed, generating an accounting report timer for the service and setting an accounting report timing signal of the generated accounting report timer as a reference accounting report timing signal; and
(c) providing accounting information for at least one service flow in progress to the accounting server in response to the timing signal of the accounting report timer.

20. The method of claim 19, further comprising the step of: when at least one of service generation, service change and service deletion is requested from the PSS, providing the accounting server with accounting information for at least one service flow in progress at the timing of the request.

21. The method of claim 19, wherein step (a) further comprises the steps of:
when at least one service is requested from the PSS, generating sessions for each service flow; and collecting accounting information of each session and recording the collected accounting information in an accounting table.

22. The method of claim 19, wherein step (b) further comprises the step of: when a previously generated accounting report timing signal exists, setting the previously generated accounting report timing signal as the reference accounting report timing signal.

23. The method of claim 19, wherein the accounting information includes at least one of information on the amount of transmitted and received packets for the service flow in an Internet protocol (IP) layer and the number of octets of the packets.

24. An accounting method in a portable Internet system providing an accounting server with accounting information for at least one service provided to a PSS, the method comprising the steps of:
(a) when a first service is requested from the PSS, generating an accounting report timing signal and providing accounting information for the first service to the accounting server;
(b) when a second service is requested from the PSS between a first timing signal and a second timing signal among the accounting report timing signals, providing accounting information for the first and second services to the accounting server upon generation of the second timing signal; and
(c) providing the accounting information for the first and second services to the accounting server according to the period of the accounting report timing signals.

25. The method of claim 24, wherein the first and second timing signals are one of the periodically generated accounting report timing signals and are generated in sequence.

26. The method of claim 24, before step (a), further comprising the step of:
when the first service is requested from the PSS, providing accounting start information for the first service to the accounting server upon the request of the first service.

27. The method of claim 24, after step (a), further comprising the step of:
when the second service is requested from the PSS, providing accounting start information for the second service and the accounting information for the first service to the accounting server upon the request of the second service.

28. The method of claim 24, after step (c), further comprising the step of:
when the third service is requested from the PSS, providing accounting start information for the third service and the accounting information for the first and second services to the accounting server upon the request of the third service.

29. The method of claim 24, after step (c), further comprising the step of:
when termination of at least one of the first and second services is requested, providing accounting stop information corresponding to each service termination request and accounting information for a service in progress to the accounting server.

30. The method of claim 24, after step (c), further comprising the step of:
when termination of a service provided to the last among the provided services is requested, stopping generation of the timing signal.

31. The method of claim 24, further comprising the steps of:
(f) generating sessions for each service requested from the PSS; and
(g) collecting accounting information of each session and recording the collected accounting information in an accounting table.

32. The method of claim 24, after step (a), further comprising the steps of:
when the second service is requested from the PSS, determining whether a previously generated timing signal exists or not; and when a new timing signal is needed, generating an accounting report timer for the service and setting an accounting report timing signal of the generated accounting report timer as a reference accounting report timing signal.

33. A computer-readable recording medium storing a program for executing a method of claim 19.
